(19) United States
(12) Patent Application Publication
(10) Pub. No.: US 2016/0199802 A1
(43) Pub. Date: Jul. 14, 2016

(54) LIQUID MOLECULE REFINEMENT AND CONTAINMENT DEVICE

(71) Applicant: Te-Hung WU, New Taipei City (TW)

(72) Inventor: Te-Hung WU, New Taipei City (TW)

(21) Appl. No.: 14/988,490

(22) Filed: Jan. 5, 2016

(30) Foreign Application Priority Data
Jan. 8, 2015 (TW) 104200304

(51) Int. Cl. B01F 11/02

(52) U.S. Cl. CPC B01F 11/02

(57) ABSTRACT

A liquid molecule refinement and containment device includes a main container having an opening formed at an appropriate position thereof; a high frequency wave oscillator installed at the opening of the main container; a control circuit module electrically connected with the high frequency wave oscillator; and a power supply module electrically connected with the control circuit module. The control circuit module converts an electric current supplied from the power supply module into an alternating current and controls the oscillation frequencies of the high frequency wave oscillator.

### CROSS-REFERENCE TO RELATED APPLICATION

This application claims the priority of Taiwanese patent application No. 104200304, filed on Jan. 8, 2015, which is incorporated herewith by reference.

### BACKGROUND OF THE INVENTION

1. Field of the Invention

The present invention relates generally to a liquid container, and more particularly to a containment device having a high frequency wave oscillator that can rearrange the liquid contained therein into clusters in nanoscale, or receive the liquid medium therein and rearrange the liquid contained in another container into clusters in nanoscale by resonance effect.

2. The Prior Arts

Conventional liquid containers have various types and functions, such as tea cups, mugs, thermos cups, sport water bottles, woks, bowls and saucers used for containing liquid therein. A conventional sport water bottle is used for containing the drinking water. When a user uses the conventional sport water bottle, the drinking water he drinks is just normal water. The drinking water in our daily life is liquid water in large clusters held together by the Van der Waals forces that exist between water molecules. Drinking the large clustered liquid water after a workout, the absorption rate is slow. Therefore, it cannot provide rapid hydration for the body.

A conventional soup bowl for containing nourishing Chinese herbal soup has the property of preventing heat loss. However, when a patient consumes the nourishing Chinese herbal soup, the nutrients cannot be fully absorbed. Because the nutritional ingredients and the water are not uniformly distributed in the soup and the water molecules are held together by the Van der Waals forces, the patient's body absorbs the nutrients slowly.

Moreover, a conventional wine brewing barrel and a liquor bottle are used for wine making and holding liquor. In the wine making, wine needs to be sealed in the wine brewing barrel and kept for years in order to provide nice taste and comfort feeling during the consumption. In addition to ethanol, the regular wine further includes organic acids and fusel alcohols, etc. Organic acids taste sour and the fusel alcohols have awful smell. Therefore, it is astringent and stingy to the throat when the wine is consumed. During the long time of storage, the organic acids and the fusel alcohols may result in esterification interactively to generate ester compounds. Since each ester has its own aroma, several esters means various types of aromas combined. Thus, the older the wine is stored, the better aromas the wine provides due to mixture of several aromas. In other words, relatively long storage time is required to brew the wine in order to eliminate the fusel alcohols and sour taste and adversely the wine thus provides nice flavor taste as well as nice smell.

### SUMMARY OF THE INVENTION

In order to solve the above-mentioned problem, a primary objective of the present invention is to provide a liquid molecule refinement and containment device that includes: a main container having an opening formed at an appropriate position thereof; a high frequency wave oscillator installed at the opening of the main container; a control circuit module electrically connected with the high frequency wave oscillator; and a power supply module electrically connected with the control circuit module, wherein the control circuit module is capable of converting an electric current supplied from the power supply module into an alternating current and controlling the oscillation frequencies of the high frequency wave oscillator.

The primary technical features of the present invention are the main container has the opening formed at the appropriate position and the high frequency wave oscillator is installed at the opening. The high frequency wave oscillator generates millions of oscillations per second through the oscillations and resonance produced by the oscillations. Thus, it directly breaks up the large molecule clusters and aggregates them again into small molecule clusters whose diameter is less than 100 nm. The core function of the high frequency wave oscillator is an application of ultrasonic cavitation effect. The high frequency wave oscillator generates millions of oscillations per second as such the ultrasonic cavitation effect is created in liquid. The ultrasonic cavitation effect is the kinetic process where the microscopic bubbles existed in the liquid is stimulated to oscillate, grow, shrink and collapse due to the high frequency waves. Taking advantage of the ultrasonic cavitation effect, it can quickly breaks up the large molecule clusters and aggregates them again into small molecule clusters whose diameter is less than 100 nm.

According to a first embodiment of the present invention, a liquid molecule refinement and containment device is a sport water bottle. The user can use the liquid molecule refinement and containment device to receive drinking water and activate the oscillator to nanolize the drinking water. The nanolization is to break up a water cluster having 50-60 water molecules (the diameter is about 1200-1500 nm) by means of the high frequency wave oscillation and aggregate them into a water cluster having 3-6 water molecules (the diameter is less than 100 nm). The principle is the circuit provides the high frequency wave oscillations to the water surface and produces an axial mechanical resonance changes, so that the water surface is bulged and the cavitation is occurred at the periphery of the bulge. The shock waves produced by the cavitation repeatedly generate oscillations, and therefore surface tension waves are occurred on the water surface. The tension waves can create a plurality of negative ions in the water. From the view of energy conversion, it is a process of transferring the electrical energy into mechanical and thermal energy. The present invention rearranges a large water cluster having 50-60 water molecules (the diameter of 1200-1500 nm) into a small water cluster having 3-6 water molecules (the diameter is less than 100 nm), which is easily absorbed by human bodies.

According to a second embodiment of the present invention, a liquid molecule refinement and containment device is a soup bowl. Upon activation of the high frequency wave oscillator, the electric current supplied from the power supply module is converted into an alternating current and the oscillation frequency of the high frequency wave oscillator is controlled—at 3 million oscillations per second for example. According to a preferred embodiment, a preset oscillation timing program is written into the control circuit module. For example, the oscillator is activated for 30 seconds each time and the oscillator is deactivated automatically after 30 seconds. After oscillation of 30 seconds, the nourishing substances and the water in the nourishing Chinese herbal soup are thoroughly and evenly distributed while the water is converted into the clusters of water molecules in nanoscale. The present invention takes advantage of small clusters of water molecules enclosing the nourishing substances and the substances that taste bitter. Because the taste receptors of the tongue first touch the water molecules, the taste of the nourishing Chinese herbal soup is optimized and the nourishing substances can be easily absorb by the human body.

According to a third embodiment of the present invention, a liquid molecule refinement and containment device is a resonance container, in which a bottle of newly brewed wine and water is received and the high frequency wave oscillator is activated to age the wine swiftly. The principle is the circuit provides the high frequency wave oscillation to be transferred to the water surface and produce an axial mechanical resonance changes. The axial mechanical resonance changes are transferred to the newly brewed wine so that the wine surface in the bottle is bulged and the cavitation is occurred at the periphery of the bulge. The shock waves produced by the cavitation repeatedly generate oscillations and surface tension waves are occurred on the wine surface, which break up the wine and water in the bottle and aggregates them again into small molecule clusters whose diameter is less than 100 nm. The clusters of water molecules enclose the alcohol. Therefore, the taste receptors of the tongue first touch the water molecules and then touch the alcohol. Thus, the taste of the wine is optimized. Moreover, the newly brewed wine further includes organic acids and fusel alcohols, etc. Organic acids taste sour and the fusel alcohols have awful smell. Therefore, it is astringent and stingy to the throat when the wine is consumed. The present invention uses the high frequency wave oscillation to speed up the esterification of the organic acids and the fusel alcohols and generate various ester compounds. After treated, the wine has mixed aromas and rich and pleasurable tastes. It does not need a long time to age. The present invention uses double container arrangement for oscillation and has the effect of swiftly aging the wine.

The conventional liquid containers are not provided with any oscillator for generating high frequency waves and cannot achieve the aforementioned effects of the present invention. The liquid molecule refinement and containment device according to the present invention can make wine swiftly aging, improving taste and even increasing the selling price. Moreover, it greatly reduces the storage space. Because the present invention can swiftly age the wine and does not need a long time to brew the wine.

According to the preferred embodiment, the liquid molecule refinement and containment device is adapted to be quickly charged by any electronic devices having USB power transmission connectors, such as notebook computers, desktop computers, portable chargers or wall socket type voltage transformers. On the contrary, the conventional liquid containers are not provided with any function or effect mentioned above.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is an exploded view showing a liquid molecule refinement and containment device according to a first embodiment of the present invention;

FIG. 2 is a schematic view showing the liquid molecule refinement and containment device according to the first embodiment of the present invention in use;

FIG. 3 is a cross sectional view showing a liquid molecule refinement and containment device according to a second embodiment of the present invention; and

FIG. 4 is a cross sectional view showing a liquid molecule refinement and containment device according to a third embodiment of the present invention.

### DETAILED DESCRIPTION OF THE PREFERRED EMBODIMENTS

The accompanying drawings are included to provide a further understanding of the invention, and are incorporated in and constitute a part of this specification. The drawings illustrate embodiments of the invention and, together with the description, serve to explain the principles of the invention, in which:

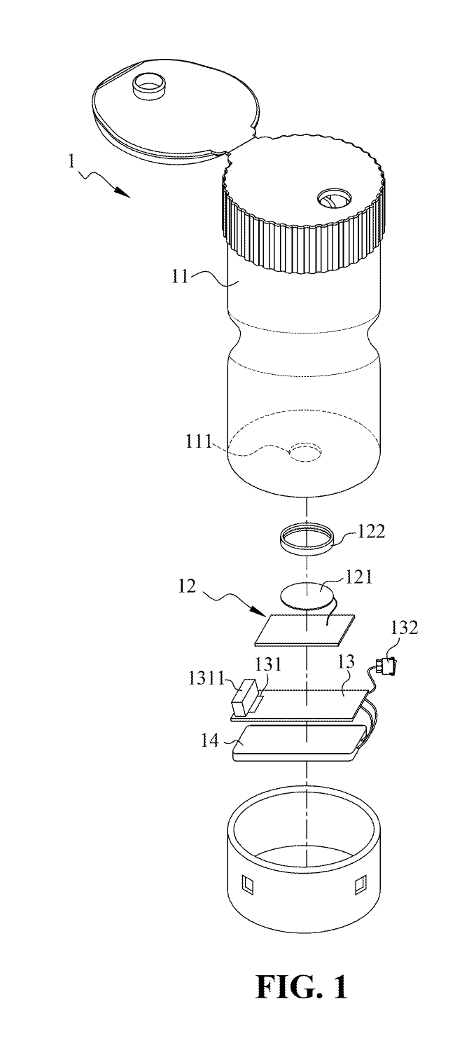

Referring to FIG. 1, FIG. 1 is an exploded view showing a liquid molecule refinement and containment device 1 according to a first embodiment of the present invention, which is capable of converting the liquid contained therein into clusters of molecules in nanoscale. The liquid molecule refinement and containment device 1 includes a main container 11, a high frequency wave oscillator 12, a control circuit module 13 and a power supply module 14. The main container 11 has an opening 111 formed at an appropriate position thereof. The high frequency wave oscillator 12 is installed at the opening 111 of the main container 11 for generating high frequency waves. The control circuit module 13 is electrically connected with the high frequency wave oscillator 12, and the power supply module 14 is electrically connected with the control circuit module 13. The control circuit module 13 is capable of converting an electric current supplied from the power supply module 14 into a high frequency alternating current and controlling the oscillation frequencies of the high frequency wave oscillator 12.

FIG. 1 illustrates the liquid molecule refinement and containment device 1 is a sport water bottle while the power supply module 14 is a lithium battery. The control circuit module 13 includes a power transmission interface 131 mounted thereon and electrically connected with the power supply module 14. The power transmission interface 131 is an interface complying with the universal serial transmission protocol and further includes a connector 1311 having a connector structure complying with the universal serial transmission protocol.

The control circuit module 13 may further include a switch device 132 mounted thereon to control the power supplied from the power supply module 14 to the high frequency wave oscillator 12. The high frequency wave oscillator 12 includes a metal oscillating piece 121 and a waterproof elastic element 122 enclosing a periphery of the metal oscillating piece 121. The metal oscillating piece 121 is disposed at the opening 111 of the main container 11 and is contacted with the water so that the water surface is bulged and the cavitation is occurred at the periphery of the bulge. The shock waves produced by the cavitation repeatedly generate oscillations and surface tension waves are occurred on the water surface, which break up the water into small clusters in 1-3 μm. Preferably, the control circuit module 13 regulates the high frequency wave oscillator 12 to make the metal oscillating piece 121 to oscillate 3 million times per second.

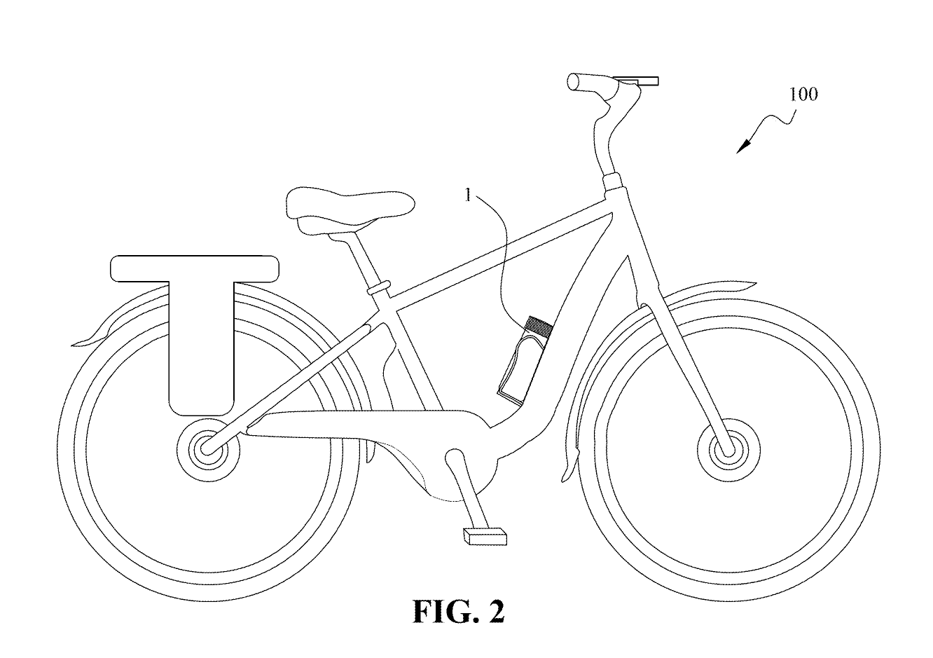

Referring to FIG. 2, FIG. 2 is a schematic view showing the liquid molecule refinement and containment device 1 according to the first embodiment of the present invention in use. The liquid molecule refinement and containment device 1 is a portable sport water bottle mounted on a bicycle 100 such that the user can carry the sport water bottle along with him. When riding the bicycle 100, the user can drink the water at break times. The sport water bottle according to the present invention can break up the large clusters of water molecules and re-aggregate the water into a plurality of small clusters of water molecules having a diameter less than 100 nm. When the water is consumed, the user's body can quickly absorb the water. Compared to the conventional sport water bottles, the conventional bottles are not provided with high frequency wave oscillator. The consumed water is large clusters of water molecules, which is slow to be absorbed by the human body.

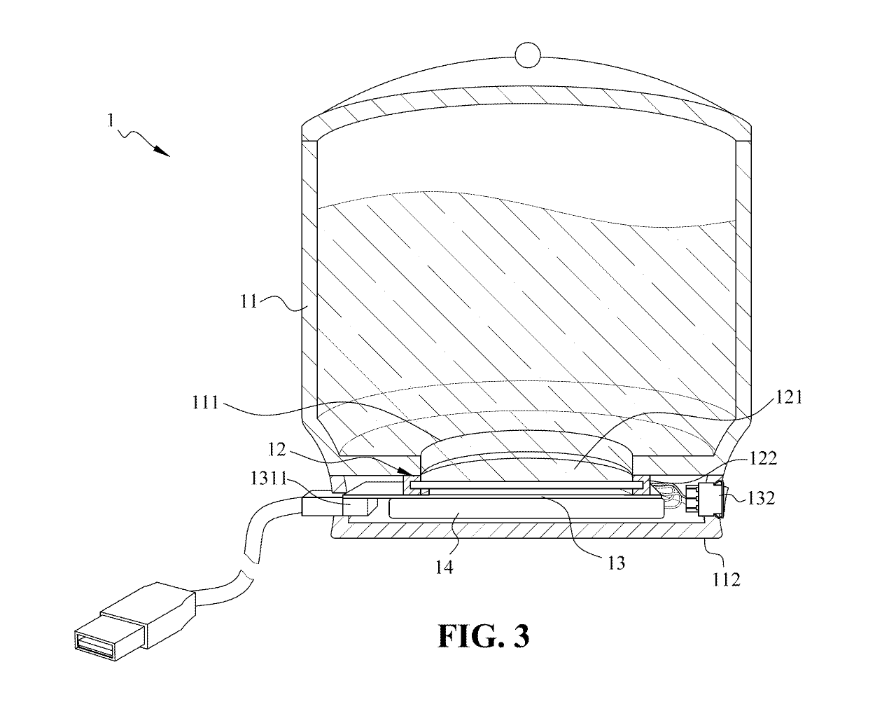

Referring to FIG. 3, FIG. 3 is a cross sectional view showing a liquid molecule refinement and containment device 1 according to a second embodiment of the present invention. The main container 11 is a soup bowl. The opening 111 is disposed at a bottom of the main container 11. The main container 11 further includes a bottom portion 112 to accommodate the high frequency wave oscillator 12, the control circuit module 13 and the power supply module 14. The oscillation frequencies of the high frequency wave oscillator 12 can reach higher than one million oscillations per second. The nourishing Chinese herbal soup is received in the soup bowl. A preset oscillation timing program is written into the control circuit module. According to an embodiment, the high frequency wave oscillator 12 is set to activate for one minute each time, such that the high frequency wave oscillator 12 is automatically shut down after one minute. After oscillating one minute, the nourishing substances and the water in the nourishing Chinese herbal soup are thoroughly and evenly distributed while the water is aggregated into the clusters of water molecules in nanoscale. The present invention takes advantage of small clusters of water molecules enclosing the nourishing substances and the substances that taste bitter. Because the taste receptors of the tongue first touch the water molecules, the taste of the nourishing Chinese herbal soup is optimized and the nourishing substances can be easily absorb by the human body.

FIG. 3 also shows the high frequency wave oscillator 12 includes a metal oscillating piece 121 and a waterproof elastic element 122 enclosing a periphery of the metal oscillating piece 121. The metal oscillating piece 121 is disposed at the opening 111 and the waterproof elastic element 122 is tightly connected to the opening 111, thereby hermetically and tightly sealing the opening 111 so as to prevent the high frequency wave oscillator 12, the control circuit module 13 and the power supply module 14 from damage due to the leakage of soup. In addition, the liquid molecule refinement and containment device 1 according to the second embodiment is a soup bowl and can be fabricated to have a structure of a thermos. A lithium battery serves as the power supply module 14. The control circuit module 13 further includes a power transmission interface 131 mounted thereon and electrically connected with the power supply module 14. The power transmission interface 131 is an interface complying with the universal serial transmission protocol and further includes a connector 1311 having a connector structure complying with the universal serial transmission protocol. Under this design, the liquid molecule refinement and containment device 1 according to the present invention is adapted to be quickly charged by any electronic devices having USB power transmission connectors, such as notebook computers, desktop computers, portable chargers or wall socket type voltage transformers.

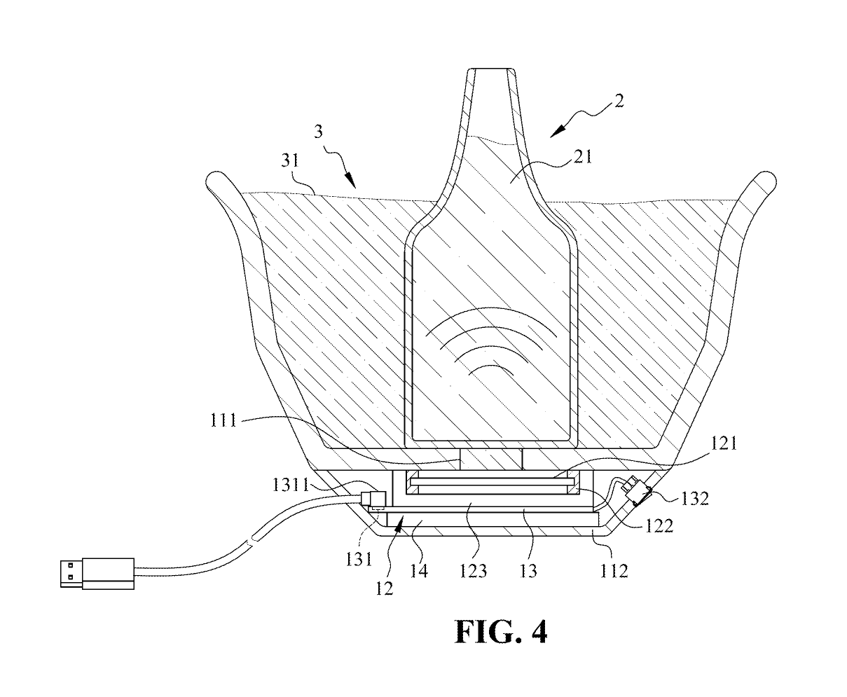

FIG. 4 is a cross sectional view showing a liquid molecule refinement and containment device according to a third embodiment of the present invention, wherein the liquid molecule refinement and containment device is a resonance container 1. As illustrated, a bottle 2 of wine can be at least partially immersed in the water 3 contained in the resonance container 1 of the present invention. In this situation, the newly brewed wine 21 in the bottle 2 can be aged swiftly because the circuit makes the high frequency wave oscillation be transferred to the water surface 31 and produce an axial mechanical resonance changes. The mechanical resonance changes are transferred to the bottle 2. The wine surface of the wine 21 in the bottle 2 is bulged and the cavitation is occurred at the periphery of the bulge. The shock waves produced by the cavitation repeatedly generate oscillations and surface tension waves are occurred in the wine 21, which break up the wine 21 in the bottle into small clusters in 1-3 μm. The clusters of water molecules enclose the alcohol. Therefore, the taste receptors of the tongue first touch the water molecules and then touch the alcohol. Thus, the taste of the wine 21 in the bottle is optimized. Moreover, the wine 21 in the bottle further includes organic acids and fusel alcohols, etc. Organic acids taste sour and the fusel alcohols have awful smell. Therefore, it is astringent and stingy to the throat when the wine is consumed. The present invention uses the high frequency wave oscillation to speed up the esterification of the organic acids and the fusel alcohols and generate various ester compounds. After treated, the wine has mixed aromas and rich and pleasurable tastes. It does not need a long time to age.

As shown in the drawing, the main container 11 of the present invention is made of a metal material while the high frequency wave oscillator 12 further includes a thermal conduction portion 123 in contact with the main container 11 to prevent the high frequency wave oscillator 12 from overheat during the operation. Because the resonance container 1 is adapted for a double container arrangement to indirectly oscillate the liquid in the bottle 2, the high frequency oscillator 12 needs the high frequency waves having a higher energy such that it is more likely to overheat. Because the thermal conduction portion 123 is in contact with the main container 11, the heat generated by the high frequency oscillator 12 can quickly dissipated from the thermal conduction portion 123 to the main container 11.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A liquid molecule refinement and containment device, comprising:
a main container having an opening formed at an appropriate position thereof;
a high frequency wave oscillator installed at the opening of the main container;
a control circuit module electrically connected with the high frequency wave oscillator; and
a power supply module electrically connected with the control circuit module,
wherein the control circuit module converts an electric current supplied from the power supply module into a high frequency alternating current and controls the oscillation frequencies of the high frequency wave oscillator.

2. The device according to claim 1, wherein the power supply module is a lithium battery.

3. The device according to claim 2, wherein the control circuit module comprises a power transmission interface mounted thereon, and the power transmission interface is electrically connected with the power supply module.

4. The device according to claim 3, wherein the power transmission interface complies with a universal serial transmission protocol and further comprises a connector having a connector structure complying with the universal serial transmission protocol.

5. The device according to claim 1, wherein oscillation frequencies of the high frequency wave oscillator are higher than 1 million oscillations per second.

6. The device according to claim 1, wherein the opening is disposed at a bottom of the main container, and the main container further includes a bottom portion to accommodate the high frequency wave oscillator, the control circuit module and the power supply module.

7. The device according to claim 1, further comprising a switch device electrically connected with the control circuit module and the power supply module.

8. The device according to claim 1, wherein the high frequency wave oscillator includes a metal oscillating piece and a waterproof elastic element enclosing a periphery of the metal oscillating piece, the metal oscillating piece is disposed at the opening of the main container, and the waterproof elastic element is connected sealingly to a periphery of the opening.

9. The device according to claim 1, wherein the main container is made of a metal material, and the high frequency wave oscillator has a thermal conduction portion in contact with the main container.
